(19) United States
(12) Patent Application Publication
(10) Pub. No.: US 2018/0021998 A1
(43) Pub. Date: Jan. 25, 2018

(54) METHOD FOR IMPROVING A BITE-SAFTE ARTIFICIAL TEAT AND LIKE PRODUCTS

(71) Applicant: Carr Lane Quackenbush, Monson, MA (US)

(72) Inventor: Carr Lane Quackenbush, Monson, MA (US)

(21) Appl. No.: 15/619,606

(22) Filed: Jun. 12, 2017

Related U.S. Application Data
(63) Continuation-in-part of application No. 15/215,881, filed on Jul. 21, 2016.

(51) Int. Cl. B29C 45/14; B29B 11/04; B29B 11/14; A61J 11/00; A61J 17/00

(52) U.S. Cl. CPC B29C 45/14786; A61J 11/0065; A61J 17/001; B29B 11/14; B29B 11/04; B29C 2045/14868; B29K 2083/00

(57) ABSTRACT

A method of making an insert for a substantially solid cylindrical article that is constructed from a highly elastic material and braided fiber forming a mesh of very specific geometry, which supports any application that requires protection from cutting, puncture or similar damage while preserving high deformability of the article, particularly radial compressibility and/or axial elongation.

### CROSS REFERENCE TO RELATED APPLICATIONS

This application is a continuation-in-part and claims benefit under 35 U.S.C. §120 of U.S. patent application Ser. No. 15/215,881, filed Jul. 21, 2016 which is incorporated herein by reference its entirety.

### TECHNICAL FIELD

The present invention relates generally to a method of making a device for feeding an infant and, more particularly, to artificial teats, nipples and similar products for feeding infants that are designed to mimic natural teats.

### DESCRIPTION OF THE RELATED ART

Newborns and infants experience many benefits from breast-milk feeding that are well documented. These benefits include providing protection against many illnesses caused by allergies, bacteria and viruses, such as stomach viruses, respiratory illness, ear infections, meningitis and the like. (See Fallot M E, Boyd J L, Oski F A. Breast-feeding reduces incidence of hospital admissions for infection in infants; Pediatrics. 1980, 65:1121-1124). Breast milk feeding also may increase intelligence and fight obesity.

There are also benefits for mothers, as twenty-four cumulative months of breast-feeding are reputed to halve the risks of breast cancer and osteoporosis.

Breast milk can be extracted using any of a number of commercially available breast pumps and fed to the infant using a bottle fitted with an artificial teat. These teats are typically constructed of silicone rubber with a hardness in the range Shore A 50 to Shore A 70. Such material has hardness and stiffness significantly higher than a mother's breast/nipple. Because of this difference, conventional artificial nipples cannot closely mimic the form and function of a nursing mother's breast/nipple.

Additionally, obstruction of the infant's airways is an ever-present danger for feeding infants with an artificial teat. Specifically, any part liberated from the artificial teat, if sufficiently small, can create a choking hazard.

Therefore, it is desirous to provide an improved approach to making artificial teats free of choking hazards.

### SUMMARY OF THE APPLICATION

During nursing, a mother's nipple elasticity elongates until it seats into the downward curve of the hard palate near the back of the baby's mouth. (See McClellan, H. L., Sakalidis, V. S., Hepworth, A. R., Hartmann, P. E. and Geddes, D. T. Validation of Teat Diameter and Tongue Movement Measurements with B-Mode Ultrasound During Breastfeeding. Ultrasound in Medicine & Biology; 2010 36 (11): 1797-1807). The total elongation depends on the geometry of a particular infant's mouth and geometry of the mother's relaxed nipple. This elongation has been reported to be as much as two times the relaxed nipple length. (See Smith, W. L., Erenberg, A. and Nowak, A. J. Imaging Evaluation of the Human Nipple During Breastfeeding; Am J Diseases in Children; 1988 142: 76-78). However, thirty to fifty percent is probably more typical.

During nursing, an infant executes a complex sequence of coordinated vacuum and mechanical tongue motions called the “suck-swallow-breathe” rhythm. During this sequence, the nipple portion of a natural teat functions in a very specific way. (See McClellan, H. L., Sakalidis, V. S., Hepworth, A. R., Hartmann, P. E. and Geddes, D. T. Validation of Teat Diameter and Tongue Movement Measurements with B-Mode Ultrasound During Breastfeeding. Ultrasound in Medicine & Biology; 2010 36 (11): 1797-1807). The steps of the suck-swallow-breathe rhythm are outlined below:
1. Initially, the tongue compresses the nipple against the roof (hard palate) of the mouth and squeezes the internal milk ducts closed, thereby shutting off milk flow. This position is known as the “fully up” position. Swallowing then ensues.
2. Just after swallowing, the tongue begins dropping from the fully up position, unclamping the nipple ducts. This action initiates the “suck” phase where an increased vacuum within the infant's mouth draws milk from the nipple into the infant's oral cavity through the ducts of the nipple. The infant stops the tongue down-motion when sufficient milk has been extracted.
3. Finally, the tongue starts back up until it is again at the fully-up position, compressing the nipple against the roof (hard palate) of the mouth, thereby squeezing the milk ducts closed, and shutting off milk flow. At this point the infant again swallows, evacuating a substantial majority of the milk in the oral cavity.

Repeated compression of the nursing mother's nipple against the infant's hard palate will cause, over time, a controlled deformation of the hard palate and thereby development of a properly-formed oral cavity with straight teeth and unrestricted sinuses. The mother's nipple enables this controlled deformation broadening of the hard palate because it is solid but deformable and allows the tongue's forces to be transmitted to the hard palate irrespective of the hard palate's shape and thereby beneficially deforming it over time. (See Palmer, B The Influence of Breastfeeding on the Development of the Oral Cavity: A Commentary: J Human Lactation: 1998: 14 (2): 93-98).

Thus, a bite-safe artificial teat having a nipple portion, formed of an elastomer, and more preferably a substantially solid elastomer, having a hardness in the range about Shore A 1 to about Shore A 25, and having at least one duct extending generally longitudinally from a distal end of said nipple portion to a proximal end of said nipple portion, a base portion attached at the distal end of the nipple portion and having an open interior volume contiguous with the distal end of the at least one duct, and a fiber mesh tube consisting of fibers that extend from near the proximal end of the nipple portion through the distal end of the nipple portion, without providing tension or compression to the nipple portion during elongation, is provided.

Additionally, proper positioning and pitch of the fiber mesh provides many desirable qualities for the bite-safe artificial teat.

Accordingly, the present invention discloses a method of making an insert for a substantially solid cylindrical article that is constructed from a highly elastic material and braided fiber forming a mesh of very specific geometry, which supports any application that requires high deformability of the article, particularly radial compressibility and/or axial elongation.

More particularly, in another aspect of the present invention, a method of making an insert for a substantially solid cylindrical article is disclosed whereby extruding a core of silicone material, wrapping fibers to form a braided fiber mesh on the extruded core, forming an overcoat layer of silicone material over the braided fiber and core, heat curing the core-braid-overcoat product, and cutting the core-braid-overcoat product into inserts is provided.

Still further, a method of making a nipple portion for a bite-safe artificial teat includes the steps of providing a mold including a first mold part containing an interior cavity to form the substantially solid cylindrical article, a second mold part to close the first mold part, and a sprue extending from an outer surface of either the first mold part or the second mold part to the interior cavity of the first mold part, placing the insert into the interior cavity of the first mold part, closing the first mold part and the second mold part, and injecting silicone material into the mold via the sprue.

These and other objects, features and advantages of the present invention will become apparent in light of the following description of non-limiting embodiments, with reference to the accompanying drawings.

### BRIEF DESCRIPTION OF THE DRAWINGS

FIG. 1 is a cross sectional view of a wide-base conventional commercial artificial nipple.

FIG. 2 is a cross sectional view of a teat containing a braided fiber mesh tube in a nipple portion of the teat.

FIG. 3 is a cross sectional view of a two-part mold for forming the nipple portion of FIG. 2, including a core pin imbedded in the mold.

FIG. 4 is a cross sectional view of the two-part mold of FIG. 3 in an open position.

FIG. 5 is a cross sectional view of the nipple portion of FIG. 2 including a pre-fabricated tubular insert.

FIG. 6 shows steps of a method for making the tubular insert of FIG. 5.

FIG. 7 is a perspective view of a braided fiber mesh tube as imbedded in the insert of FIG. 5.

FIG. 8 shows schematically a geometric derivation of the “correct” fiber mesh tube pitch for a given tube diameter.

FIG. 9 shows, in tabular form, the calculated “correct” pitch values for fiber mesh tubes of different diameter.

FIG. 10 shows, in tabular form, experimental elongation results of samples having different pitch values for the fiber mesh tube and the calculated stretch at 50% elongation for each sample.

FIG. 11 shows a graphical representation of the experimental elongation results of samples having different pitch values for the fiber mesh tube.

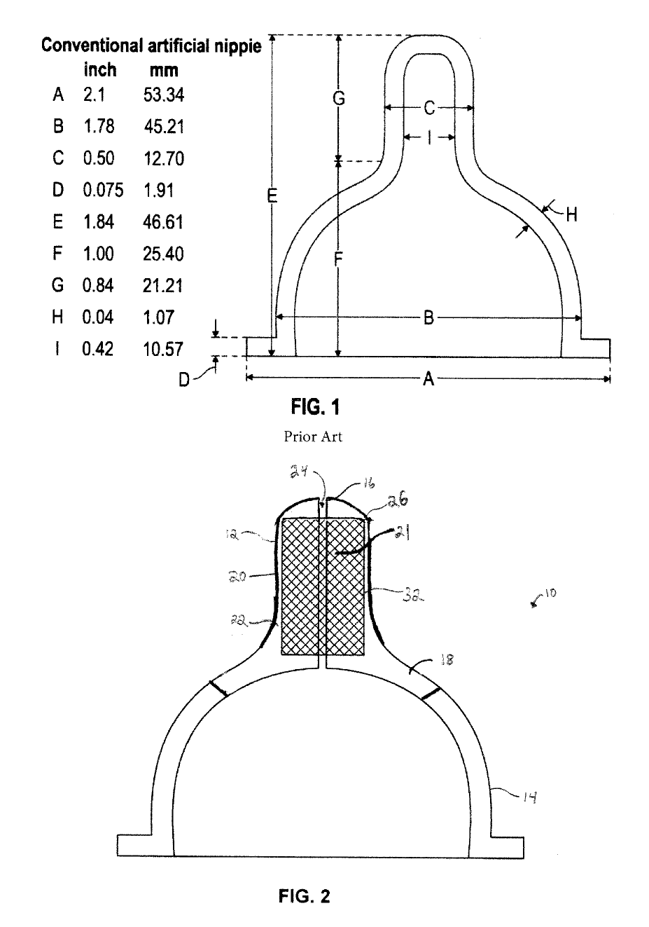

### DETAILED DESCRIPTION OF THE DRAWINGS

The following descriptions of the figures will convey details of construction and operation of a bite safe, artificial teat in accordance with the present invention.

Referring to FIG. 2, a teat 10 is formed of a substantially solid nipple portion 12 and a hollow base portion 14. The substantially solid nipple portion 12 has a proximal end 16 for insertion into an infant's mouth, a distal skirt 18 for connecting the substantially solid nipple portion 12 to the hollow base portion 14, a nipple barrel 20 extending from the proximal end 16 to the distal skirt 18, and a core 21 enclosed within the nipple barrel. The substantially solid nipple portion 12 is preferably fabricated in multiple soft elastomer parts (e.g. silicone rubber having a hardness in the range Shore A 1 to Shore A 25) forming an elastomeric matrix 22. The substantially solid nipple portion further includes a nipple duct 24 extending through the substantially solid nipple portion 12 from the proximal end 16 to the distal skirt 18.

The hollow base portion 14 connects the nipple portion 12 to a feeding container, for example, a bottle or bag (not shown).

In certain preferred embodiments, as shown in FIG. 6, the substantially solid nipple portion 12 is composed of a tubular insert 26 fabricated from a combination of soft elastomers and fibers. For example, the tubular insert 26 includes a soft elastomer core 28 (e.g. silicone rubber having a hardness in the range Shore A 10 to Shore A 25), fibers 30 wrapped onto the soft elastomer core 28 forming a fiber mesh 32, and an overcoat layer 34 (e.g. silicone rubber having a hardness in the range Shore A 10 to Shore A 25) covering the fiber mesh 32.

Referring back to FIG. 2, the hollow base portion 14 can be fabricated with a higher hardness material than the nipple portion 12, e.g., silicone rubber having a hardness in the range Shore A 20 to Shore A 70. Proximal and distal are used in their medical sense and directionally with respect to the nursing infant. Thus, “proximal” is closest to the nursing infant, and the proximal portion of the teat 10 and nipple portion 12 is that portion which the infant draws into its mouth. The “distal” portion of the teat 10 is that portion farthest from the nursing infant, namely, the base portion 14 which attaches the nipple portion 12 to the feeding container. The entire structure, including the two sub parts, nipple portion 12 and base portion 14, is referred to collectively as the teat 10.

In accordance with the present invention, the nipple portion 12, or small parts of it liberated by bite-through, will remain attached to the teat 10 by the helically wound fiber mesh 32, typically made of high strength polymer fiber—e.g., polyethylene, polypropylene or polyester and having a significantly higher tensile strength and stiffness than the elastomeric matrix 22 or elastomers of the tubular insert 26. Thus, no part of the nipple portion 12 can become separated by bite-through due to the fiber mesh 32.

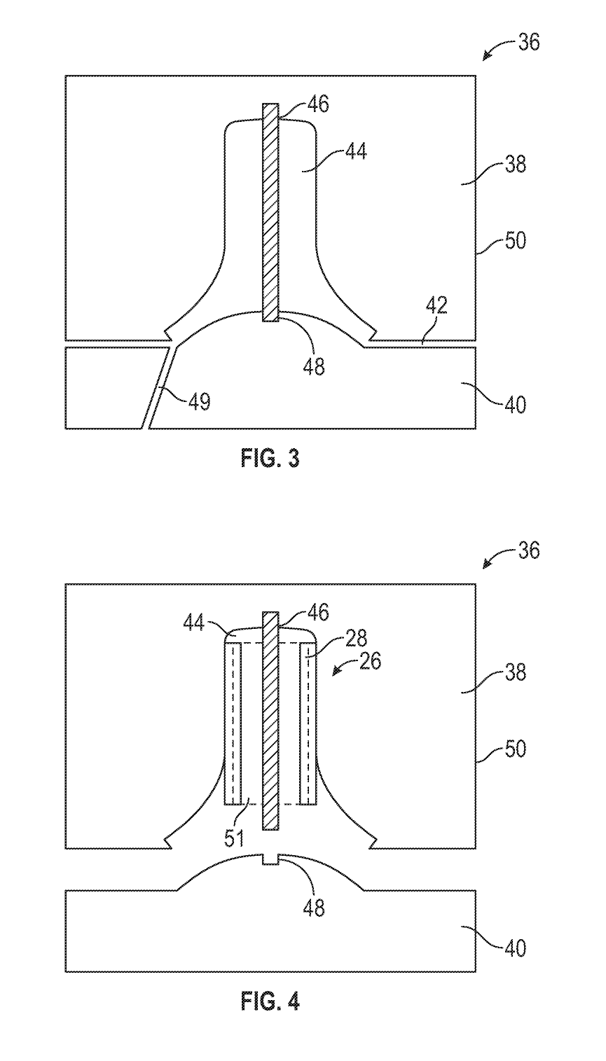

Referring to FIG. 3, an injection molding manufacturing process for producing the nipple portion 12 of the present invention includes providing a two piece mold 36 having a first proximal portion 38 and a second distal portion 40. A parting line 42 separates the first proximal portion 38 and the second distal portion 40.

The first proximal portion 38 includes a cavity 44 that forms the nipple portion 12 when material is injected into the mold 36, and an imbedded core pin 46 extending through the cavity 44. In certain embodiments, the imbedded core pin 46 extends into a groove 48 of the second distal portion 40.

The second distal portion 40 forms the distal skirt 18 of the nipple portion 12 when material is injected into the mold 36. A sprue 49 extends from an outer surface 50 of the mold 36 to the cavity 44 and provides a means for injected silicone rubber to enter the mold 36. In certain embodiments, the sprue 49 is disposed within the second distal portion 40. In certain embodiments, the sprue 49 is disposed within the first proximal portion 38. The sprue 49 is generally a single channel different than the parting line 42, but can be coextensive with the parting line 42 in certain embodiments.

Referring to FIG. 4, a compression molding manufacturing process for producing the nipple portion 12 of the present invention includes squirting silicone rubber within the cavity 44, for example, within a bore 51 of the elastomer core 28 of the tubular insert 26, and closing the second distal portion 40 against the first proximal portion 38. In the compression molding approach, excess (uncured) silicone rubber leaves the mold 36 through the parting line 42. Once the mold 36 is closed, the mold is put into a press with heated platens (not shown). Heat from platens cures the rubber.

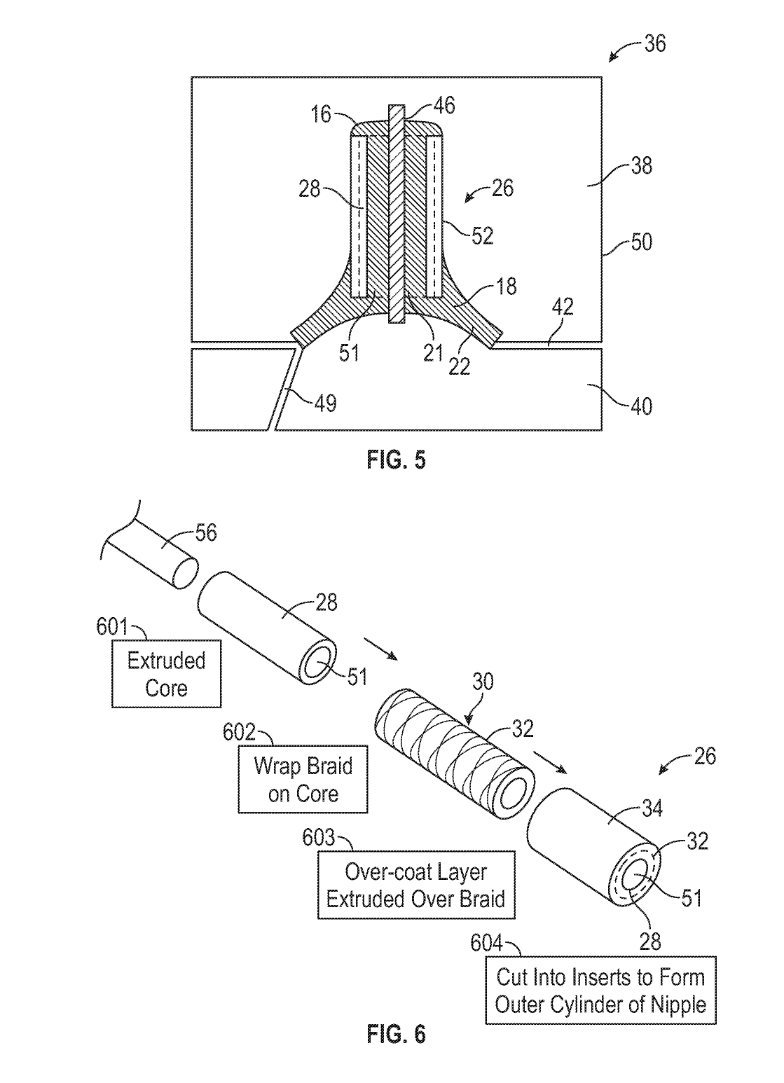

Referring to FIG. 5, the tubular insert 26 is placed within the cavity 44. In certain embodiments, the tubular insert 26 is sized to fit tightly against sidewalls 52 of the cavity 44 with the imbedded core pin 46 extending through the bore 51 of the tubular insert 26.

To collectively form the nipple portion core 21, proximal end 16 and distal skirt 18, silicone rubber, for example silicone rubber having a hardness in the range Shore A 1 to Shore A 10, is injected through the at least one sprue 49 while the imbedded core pin 46 is in place. When the silicone rubber is injected, the core pin 46 forms the nipple duct 24.

Referring to FIG. 6, according to certain embodiments, the tubular insert 26 is formed by the following steps. First, at step 601, the soft elastomer core 28 is extruded. In certain embodiments the soft elastomer core 28 is extruded over a mandrel 56 that is later removed. Next, at step 602, the fibers 30 are wrapped onto the soft elastomer core 28 to form the tubular braided fiber mesh 32. Then, at step 603, the overcoat layer 34 (i.e. a thin layer of silicone material) is formed over the fiber mesh braid 32. Finally, at step 604 the soft elastomer core 28, wrapped fiber mesh 32, and overcoat layer 34 is heat treated to cure the silicone, and then cut into inserts 26.

As described, the fiber mesh braid 32 is encased between two layers of silicone 28, 34. The tubular insert's 26 structure provides sufficient body and handling strength so that when the insert 26 is placed into the mold 36 (as shown in FIG. 4) the position of the mesh tube 32 along the nipple barrel 20 and the pitch of the mesh fibers 30 are not disrupted when the silicone rubber is introduced to form the nipple core 21, proximal end 16 and distal skirt 18.

Referring back to FIG. 5, in certain embodiments, the bore 51 of tubular insert 26 is sufficiently large so that injected elastomeric matrix 22 material can freely flow through the bore 51 to form the central core of the nipple 21 around the core pin 46, the nipple proximal end 16, and the distal skirt 18 without disrupting, displacing or deforming the fiber mesh 32 within the insert 26.

A further advantage of the method of the present disclosure is that the process described in FIGS. 3, 5 and 6 is a continuous production process to produce tubular inserts 26.

Another advantage of the method of the present disclosure is that the tubular inserts 26 can be produced consistently and at a lower cost than creating individual inserts 26.

Another advantage of the method of the present disclosure is that the substantially solid nipple portion 12 has multiple parts: a core 21 of soft silicone (e.g. silicone having a hardness in the range Shore A 1 to Shore A 10) surrounded by the tubular insert 26 having the soft elastomer core 28 (e.g. silicone having a hardness in the range Shore A 10 to Shore A 25) and the overcoat layer 34 of silicone (e.g. silicone having a hardness in the range Shore A 10 to Shore A 25). In certain embodiments, the hardness of the nipple core 21, proximal end 16, and distal skirt 18 and the hardness of materials used to construct the tubular insert 26 may be the same. In certain embodiments, the hardness of the nipple core 21, proximal end 16, and distal skirt 18 may be the same, while the hardness of materials used to construct the tubular insert 26 may be different. In other embodiments, the nipple core 21, proximal end 16, distal skirt 18, tubular insert 26 soft elastomer core 28 and overcoat layer 34 may all have a different hardness. Ability to control properties of these different parts allows the nipple portion to be customized to best satisfy manufacturing, cost and customer needs.

Another advantage of the method of the present disclosure is that the ability to independently control the hardness of the tubular insert's 26 overcoat layer 34. Controlling the hardness of the overcoat layer 34 allows for control of the degree of stickiness on an outer surface of the nipple barrel 20. This is because, typically, harder silicones are less sticky.

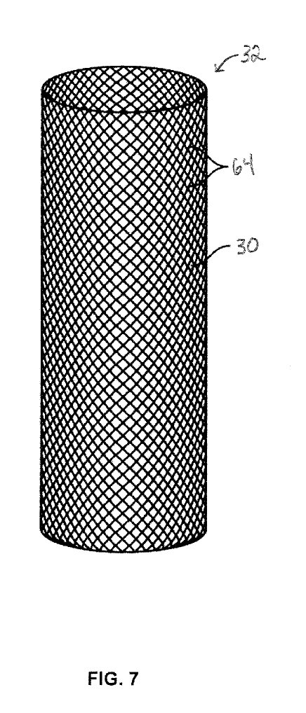

Referring to FIG. 7, wrapping the fibers 30 to form the mesh 32 imbedded between the insert tube's elastomer core 28 and its overcoat layer 34 forms a roughly cylindrical fiber mesh tube 32. This tube 32 can be positioned near the outer surface of the tubular insert 26 such that it lies entirely below the surface, but otherwise is disposed close to the outer surface.

When positioned near the outer surface of the insert 26, the mesh tube 32 acts also as a “safety fence” or “bite fence” to resist biting forces from an infant's teeth, which could tear the nipple portion without the presence of the mesh tube 32. In the case of biting damage sufficient to sever the soft matrix elastomer core 21 inside the fiber mesh tube 32, a bitten nipple piece would remain attached to the teat 10 by way of the mesh tube 32, thereby eliminating any danger of the bitten piece becoming a choking hazard. Thus, the fiber mesh tube 32 mechanically maintains connection between a small separated piece of nipple 12, which might otherwise become a choking hazard.

Still referring to FIG. 7, the mesh tube 32 is preferably fabricated of fibers 30 helically wound in opposite directions thus forming a braided tubular shape and having crossover points 64. One advantage of the present invention as an attachment device is that during the making of the tubular insert 26, the core elastomer 28 and/or the overcoat elastomer 34 will fill the interstitial diamond spaces between fibers 30 of the braided mesh 32 and thus the mesh tube 32 will be firmly attached to the elastomer of the tubular insert 26, which, in turn, is firmly bonded to the soft elastomer which forms the core of the nipple 21, proximal end 16, and distal skirt 18. Further strengthening of the attachment between the individual fibers 30 and the elastomeric matrix 22 in which they are imbedded can be achieved by utilizing multi-filament fibers (“yarn”) in which, during molding the soft elastomer would be expected to percolate between the yarn strands. Moreover, cut resistance tends to be better for yarns than monofilament fibers. In this regard, some fibrous materials have better cut resistance than others, e.g., ultrahigh molecular weight polyethylene is better than polyester.

Generally, a helically braided fiber tube imbedded in the near surface of a solid right cylinder or tube of polymeric material would be expected to strengthen the structure and as a consequence increase its stiffness and thereby limit its ability to deform (in elongation, radial compression or radial expansion). See, for example, U.S. Pat. No. 5,630,802 to Inagaki et al., which utilizes a wrapped fiber layer to reinforce medical tubing. However, as noted in connection with the “suck-swallow-breathe” rhythm, it is desirous for optimal operation of an artificial teat to have the nipple portion of the teat easily compress and elongate within an infant's oral cavity in response to the infant's sucking/swallowing as well as the mechanical movement of the infant's tongue.

The mechanical behavior of the present invention specifically avoids such stiffening, which would detrimentally restrict compression and/or elongation of the nipple. In use, axial or radial mechanical deformations of the nipple portion 12 of the present invention by 50% or more are expected and desired.

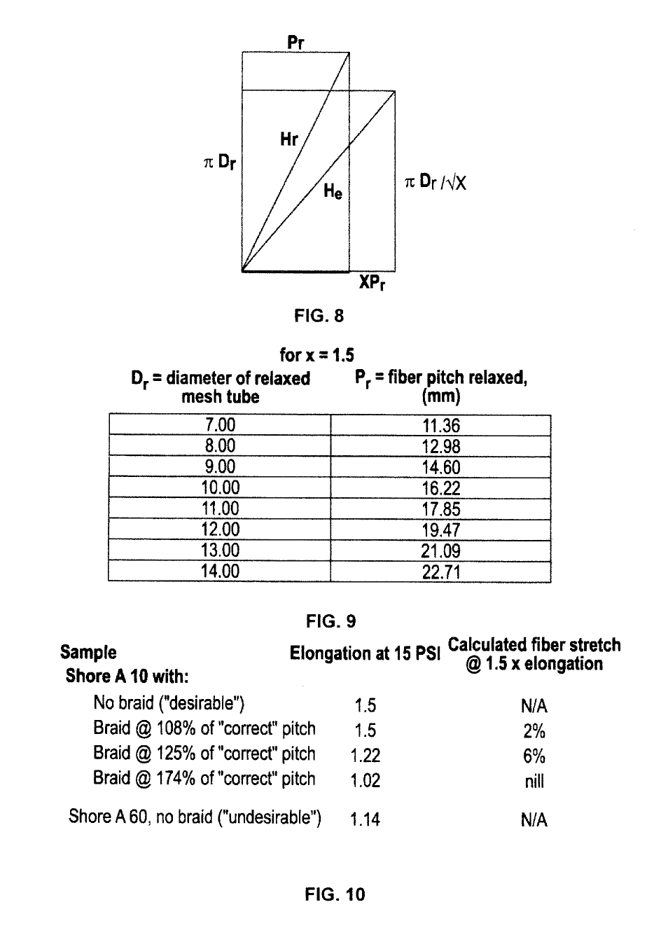

Referring to FIG. 8, the fibers 30 and the braided mesh tube 32 they form can be described by the following geometric parameters:

Dᵣ=Relaxed diameter=diameter of the mesh tube when the teat is relaxed, not elongated.

Dₑ=Elongated diameter=diameter of the mesh tube when the teat is elongated, generally up to a fractional elongation of 1.5 times the relaxed length. Dₑ will always be less than D₁.

Pᵣ=pitch of the fiber when the core is relaxed=the distance along the (relaxed) length needed for each fiber to make one complete wrap.

Pₑ=(calculated) pitch of the fiber when the core is elongated by a factor of X, Pₑ=the distance along the (elongated) length needed for each fiber to make one complete wrap. Pₑ=X Pᵣ.

X=the fractional length elongation. For example if Pᵣ=1.0 and Pₑ=1.5, then X=1.5.

Hᵣ=relaxed hypotenuse length=length of an individual fiber having made one complete wrap when the “core” is relaxed.

Hₑ=elongated hypotenuse length=(calculated) length of an individual fiber having made one complete wrap when the “core” is elongated.

It is assumed that volume of the soft, elastic polymeric material occupying the entire volume of the “core” (a right cylinder) inside the mesh tube 32 is the same when it is relaxed and when it is extended (conservation of volume principle). Therefore, if the nipple portion 12 of the artificial teat 10 is modeled as a solid right cylinder and if the length of that cylinder is extended by 50% (i.e. X=1.5) and assuming no change in volume of the elastomer cylinder, then the diameter will decrease to about 82% of its original value.

The individual fibers 30 could be thin, for example about 0.004 to about 0.01 inches in diameter, more preferably about 0.006 inches in diameter to be flexible, but also strong, for example between about 5-25 lb. breaking strength, more preferably about 15 lb. breaking strength.

The individual fibers 30 will trace helical paths around the right cylinder of the “core”. Referring to FIG. 8, if the surface of the relaxed “core” is “unrolled”, an individual fiber will lie on the hypotenuse of a triangle where one side is the circumference of the right cylinder of the “core” (=π Dᵣ) and the other leg=Pᵣ.

From the Pythagorean theorem, (Hᵣ)²=(π D₁)²+(Pᵣ)².

When the “core” is extended by a factor, X, the new pitch of the fiber will be Pₑ=X Pᵣ and the diameter will reduce from Dᵣ to Dₑ. Assuming conservation of volume, Dₑ=Dᵣ/√X. Now, the individual fibers will trace a different helical path around the right cylinder of the extended “core”. If the surface of this extended “core” is “unrolled”, an individual fiber will lie on the hypotenuse of a triangle where one side is the circumference of the (smaller) right cylinder of the “core” (=π Dₑ=π Dᵣ/√X) and the other leg is the new pitch of the fiber=Pₑ=X Pᵣ.

From the Pythagorean theorem (Hₑ)²=(π Dᵣ/√X)²+(XPᵣ)². (See FIG. 8).

In order for the fibers 30 not to change the desired properties of the soft elastomer of the nipple portion 12, the fibers 30 must not appreciably change its length i.e., experience significant tension or compression when the nipple portion 12 is elongated. Mathematically, this means the hypotenuse of the fibers 30 when imbedded in the relaxed core (described above) and the hypotenuse of the fibers 30 when imbedded in the core elongated by X (described above) must have the same length.

Having the same length means the relaxed hypotenuse must equal the elongated hypotenuse:

(Hᵣ)²=(Hₑ)² and so: (π Dᵣ)²+(Pᵣ)²=(π Dᵣ/√X)²+(XPᵣ)²

So: Pᵣ=√(((π D₁)²−(π Dᵣ/√X)²)/(X²−1))

Or: Pᵣ=π Dᵣ√((1−1/X)/((X²−1))

For every nipple diameter there will be an effective diameter of the (relaxed) mesh tube (Dᵣ). Assuming an elongation of 50% (i.e. X=1.5) there will be an ideal pitch length (Pᵣ) for the fibers that allows them to experience neither tension nor compression when the teat is elongated by 50% (i.e. X=1.5). For the case of X=1.5; Pᵣ=1.62 Dᵣ.

For X=1.5 and various Dᵣ values, the Pᵣ values that meet this requirement are provided in FIG. 9.

### Experimental Results

Referring to FIG. 10, cylindrical samples of silicone rubber having Shore A hardness of 10 or 60 with or without helically wound braided fiber tubes imbedded in the near surface were prepared. Each sample had a specific Dᵣ (diameter of the mesh tube when the cylinder is relaxed, not elongated) and Pᵣ (pitch of the fiber when the core is relaxed). Samples were progressively weighted to elongate them, if possible, up to 150%. Considering the reduced cross sectional area, the applied stress was calculated for each weight and the percentage elongation noted.

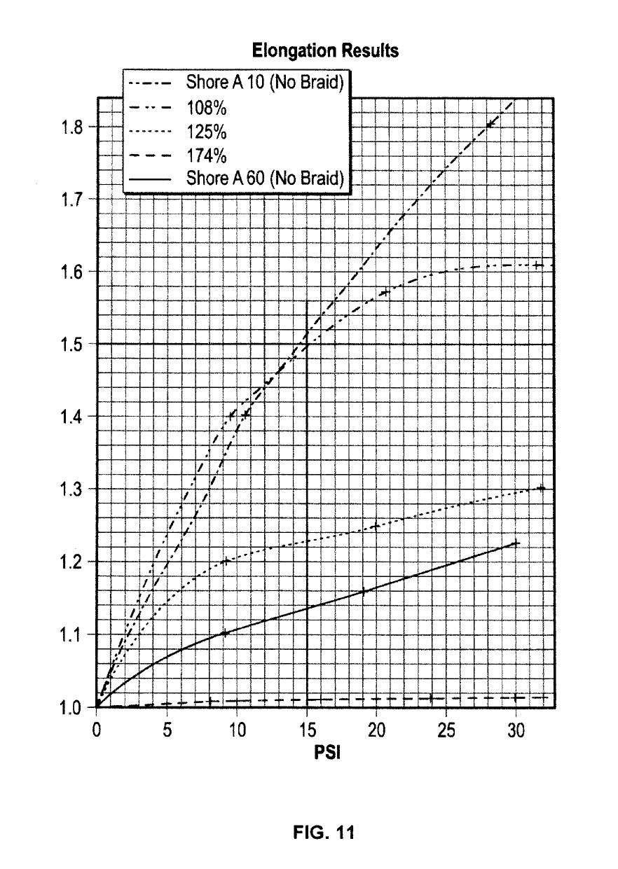

FIG. 11 plots results described in FIG. 10. Stress vs. elongation behavior for the silicone rubber Shore A 10 material with no fiber was the benchmark for “desirable” performance. Stress vs. elongation behavior for the silicone rubber Shore A 60 material with no fiber was the benchmark for “undesirable” performance.

A first sample cylinder was prepared of silicone rubber having Shore A 10 hardness and no fiber mesh tube. Its elongation was measured under increasing applied stress. A second sample cylinder was prepared of silicone having Shore A 10 hardness with fiber mesh tube imbedded having 108% of the “correct” pitch for the diameter of the sample cylinder.

As shown in FIGS. 10 and 11, under 15 psi applied stress the second sample cylinder elongated to X=1.5, substantially the same as the first sample cylinder having no fiber mesh. Using the methodology described in FIG. 8, the calculated stretch for fibers in the second sample cylinder at an elongation of X=1.5, was 2%. A third sample cylinder was prepared of silicone rubber having Shore A 10 hardness with fiber mesh tube imbedded having 125% of the “correct” pitch. As noted, the third sample cylinder at 15 psi applied stress elongated only to X=1.22. The calculated stretch for fibers in the third sample cylinder if it had been able to elongate to X=1.5 would have been 6%. A fourth sample cylinder was prepared of silicone rubber having Shore A 10 hardness with fiber mesh tube imbedded having 174% of the “correct” pitch. This fourth sample cylinder barely elongated under 15 psi applied stress. By comparison, a fifth sample of silicone rubber Shore A 60 polymer having no fiber mesh elongated further than the fourth sample cylinder, but less than the third.

The results above and data presented in FIGS. 10 and 11 demonstrate that under 15 psi applied stress and for elongations up to X=1.5, a sample with fiber mesh tubes having 108% of the “correct pitch” and experiencing a (calculated) fiber stretch of 2% does not appreciably degrade stress vs. elongation properties in comparison to a silicone rubber Shore A 10 sample having no fiber mesh. Under the same loading conditions however, a sample with a fiber mesh tube having 125% of the “correct pitch” and experiencing a (calculated) fiber stretch of 6%, demonstrated stress vs. elongation properties better than the Shore A 60 sample having no fiber mesh, but considerably worse than the Shore A 10 sample having no fiber mesh. Accordingly, the data demonstrates that addition of a fiber mesh tube having 108% of the correct pitch and 2% fiber stretch is acceptable whereas addition of fiber mesh tubes having 125% of the correct pitch and 6% fiber stretch is not acceptable. Although not shown experimentally, the data allows for extrapolation that up to 3% fiber stretch corresponding to 115% of the “correct” pitch would be acceptable. Accordingly, the same range may hold true in the case of fiber compression.

Based on the extensive testing and notation of acceptable and unacceptable results, the preferred range is ±15% of “correct” fiber pitch Pr where Pr=πDr°(1−1/X)/((X²−1)).

While the present invention addresses feeding breast milk to an infant, the artificial teat described in the present invention may also be used to feed “formula” either as a supplement to the mother's own breast milk or as the infant's exclusive food source.

Although described for feeding of human infants, the present invention could be used also for feeding of other animals. Teachings of this invention may also be used for non-feeding devices such as infant pacifiers or other products, which benefit from soft, elastic polymeric materials that are subject to damage, for example biting and the like, which would break the product into undesirable pieces, rendering the product unsafe, unusable or otherwise unacceptably damaged.

An advantageous aspect of the present invention is that the fibers 30 of the braided fibrous mesh tube 32, when introduced in the disclosed very specific configuration, experience neither significant tension nor compression as the teat is compressed and/or elongated in use, and so does not act to mechanically “reinforce” the soft, elastic matrix phase, which would diminish softness and thereby inhibit desired operation of the nipple portion 12. Thus, the disclosed specific configuration of the braided fibrous mesh tube avoids creating a classic load-transfer composite, which would degrade the soft, elastic properties of the matrix phase that are needed for the desired functioning of the artificial teat.

Additionally, teachings of this invention may also be used for Continuous Positive Airway Pressure (“CPAP”) machines. Specifically, the above described “bite fence” may prevent choking hazards caused by separation of parts of the breathing apparatus used to treat infants or adults who have respiratory distress syndrome, bronchopulmonary dysplasia, sleep apnea and the like.

Additionally, teachings of this invention may also be used for pacifiers. Specifically, the above described method of making the insert 26 may prevent choking hazards for infants that bite a pacifier.

Further, teachings of this invention may also be used for other cylindrical products that benefit from having a soft, substantially solid core and that benefit from having that soft substantially solid core protected from piercing, cutting or other forms of damage to the soft substantially solid core, but without significantly degrading softness of the core.

Although this invention has been shown and described with respect to the detailed embodiments thereof, it will be understood by those skilled in the art that various changes in form and detail thereof may be made without departing from the spirit and scope of the invention.

Additionally, it is also to be understood that the terminology used is for the purpose of describing particular embodiments only, and is not intended to limit the scope of the claims of the present invention.

What is claimed is:

1. A method of making an insert for a substantially solid cylindrical article, the method comprising the steps of:
extruding a core of silicone material;
wrapping fibers to form a braided fiber mesh on the extruded core;
forming an overcoat layer of silicone material over the braided fiber and core to form a core-braid-overcoat product;
heat-curing the core-braid-overcoat product; and
cutting the core-braid-overcoat product to produce the insert.

2. The method according to claim 1, wherein the step of extruding the core of silicone material is performed over a mandrel.

3. The method according to claim 2, further comprising the step of removing the mandrel after the step of extruding the core of silicone material, but before the step of cutting the heat-cured core-braid-overcoat product.

4. The method according to claim 1 further comprising the steps of:
providing a mold comprising:
a first mold part containing an interior cavity to form the substantially solid cylindrical article;
a second mold part to close the first mold part; and
a sprue extending from an outer surface of the mold to the interior cavity of the first mold part;
placing the insert into the interior cavity of the first mold part;
closing the first mold part and the second mold part; and
injecting silicone material into the mold.

5. The method according to claim 1, wherein the core of the insert has a hardness in the range of Shore A 10 to Shore A 25.

6. The method according to claim 1, wherein the overcoat layer has a hardness in the range of Shore A 10 to Shore A 25.

7. The method according to claim 1, wherein the fibers have a higher tensile strength and elastic modulus than the silicone core and silicone overcoat layer of the insert, and
wherein under a given applied stress, the presence of the fiber does not degrade elongation of the silicone core and silicone overcoat layer by more than 10%.

8. The method according to claim 1, wherein the fibers form a fiber mesh tube.

9. The method according to claim 8 wherein the fibers of the fiber mesh tube are arranged at a pitch Pᵣ that is determined according to Pᵣ=π Dᵣ√((1−1/X)/((X²−1)) in which Dr is the relaxed diameter of the fiber mesh tube and X is the fractional elongation at which the fiber mesh tube exhibits no tensile stress.

10. The method according to claim 9 wherein the fiber mesh tube is a helically wound braid at ±15% of the pitch Pᵣ for a specific diameter.

11. The method according to claim 8 wherein the fibers are bonded at crossover points.

12. The method according to claim 8 wherein in the fibers form a diamond-pattern mesh.

13. A pacifier incorporating an insert made according to the method of claim 1.

14. A method of making a nipple portion for a bite-safe artificial teat, the method comprising the steps of:
forming an insert by;
extruding a core of silicone material;
wrapping fibers to form a braided fiber mesh tube on the extruded core;
forming an overcoat layer of silicone material over the braided fiber mesh tube and core;
heat-curing the core-braid-overcoat product; and
cutting the core-braid-overcoat product to produce the insert;
providing a mold comprising:
a first mold part containing an interior cavity to form the substantially solid cylindrical article;
a second mold part to close the first mold part; and
a sprue extending from an outer surface of either the first mold part or the second mold part to the interior cavity of the first mold part;
placing the insert into the interior cavity of the first mold part;
closing the first mold part and the second mold part; and
injecting silicone material into the mold via the sprue.

15. The method according to claim 14, wherein the first mold part includes a core pin extending into the interior cavity to form an axial duct through the bite-safe artificial teat.

16. The method according to claim 14, further comprising the steps of:
injecting silicone material through the sprue to form a core of the nipple portion; and
bonding an inside surface of the insert to a formed distal skirt of the nipple portion.

17. The method according to claim 14, wherein the interior cavity of the first mold part extends past the insert in a proximal and a distal direction and the injected silicone material forms a proximal end and a distal end of the nipple portion.

18. The method of claim 14, wherein the injected silicone material has a hardness in the range Shore A 1 to Shore A 10.

19. The method of claim 14, wherein the core of silicone material has a hardness in the range of Shore A 10 to Shore A 25 and the overcoat layer has a hardness in the range of Shore A 10 to Shore A 25.

20. The method of claim 14, wherein the fibers comprise monofilament or multifilament material selected from the group consisting of polyethylene, polypropylene and polyester.

21. A bite-safe artificial teat having a nipple portion made according to the method of claim 14.

22. A method for forming a cylindrical article including the steps of:
providing a cylindrical silicone elastomeric material having a hardness in the range of Shore A 1 to Shore A 25; and
imbuing the elastomeric material with a mesh to protect against biting or other damage;
wherein the properties of the silicone material are not degraded when the silicone elastomeric material and mesh is stretched.
